(19) United States
(12) Patent Application Publication
(10) Pub. No.: US 2023/0155772 A1
(43) Pub. Date: May 18, 2023

(54) REFERENCE SIGNAL ORTHOGONALITY

(71) Applicant: QUALCOMM Incorporated, San Diego, CA (US)

(72) Inventors: Qian ZHANG, Basking Ridge, NJ (US); Yan ZHOU, San Diego, CA (US); Fang YUAN, Beijing (CN); Tao LUO, San Diego, CA (US); Navid ABEDINI, Basking Ridge, NJ (US); Junyi LI, Fairless Hills, PA (US); Tianyang BAI, Somerville, NJ (US); Kiran VENUGOPAL, Green Brook, NJ (US); Jung Ho RYU, Fort Lee, NJ (US)

(21) Appl. No.: 17/907,642

(22) PCT Filed: Jun. 5, 2020
(86) PCT No.: PCT/CN2020/094592

§ 371 Date: Sep. 28, 2022

(51) Int. Cl. H04L 5/00; H04L 5/14

(52) U.S. Cl. CPC H04L 5/0051; H04L 5/0007; H04L 5/14

(57) ABSTRACT

Various aspects of the present disclosure generally relate to wireless communication. In some aspects, a wireless node may communicate, using a first antenna panel, a first reference signal (RS) based at least in part on a first RS configuration, and communicate, simultaneously with the first RS and using a second antenna panel that is different than the first antenna panel, a second RS based at least in part on a second RS configuration, wherein the second RS configuration orthogonalizes the second RS relative to the first RS. Numerous other aspects are provided.

### FIELD OF THE DISCLOSURE

Aspects of the present disclosure generally relate to wireless communication and to techniques and apparatuses for reference signal orthogonality.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a wireless node, may include communicating, using a first antenna panel, a first reference signal (RS) based at least in part on a first RS configuration, and communicating, simultaneously with the first RS and using a second antenna panel that is different than the first antenna panel, a second RS based at least in part on a second RS configuration, wherein the second RS configuration orthogonalizes the second RS relative to the first RS.

In some aspects, a method of wireless communication, performed by an integrated access and backhaul (IAB) node, may include communicating a first RS based at least in part on a first RS configuration, and communicating, simultaneously with the first RS, a second RS based at least in part on a second RS configuration, wherein the second RS configuration orthogonalizes the second RS relative to the first RS.

In some aspects, a wireless node for wireless communication may include a memory and one or more processors operatively coupled to the memory. The memory and the one or more processors may be configured to communicate, using a first antenna panel, a first RS based at least in part on a first RS configuration, and communicate, simultaneously with the first RS and using a second antenna panel that is different than the first antenna panel, a second RS based at least in part on a second RS configuration, wherein the second RS configuration orthogonalizes the second RS relative to the first RS.

In some aspects, an IAB node for wireless communication may include a memory and one or more processors operatively coupled to the memory. The memory and the one or more processors may be configured to communicate a first RS based at least in part on a first RS configuration, and communicate, simultaneously with the first RS, a second RS based at least in part on a second RS configuration, wherein the second RS configuration orthogonalizes the second RS relative to the first RS.

In some aspects, a non-transitory computer-readable medium may store one or more instructions for wireless communication. The one or more instructions, when executed by one or more processors of a wireless node, may cause the one or more processors to communicate, using a first antenna panel, a first RS based at least in part on a first RS configuration, and communicate, simultaneously with the first RS and using a second antenna panel that is different than the first antenna panel, a second RS based at least in part on a second RS configuration, wherein the second RS configuration orthogonalizes the second RS relative to the first RS.

In some aspects, a non-transitory computer-readable medium may store one or more instructions for wireless communication. The one or more instructions, when executed by one or more processors of an IAB node, may cause the one or more processors to communicate a first RS based at least in part on a first RS configuration, and communicate, simultaneously with the first RS, a second RS based at least in part on a second RS configuration, wherein the second RS configuration orthogonalizes the second RS relative to the first RS.

In some aspects, an apparatus for wireless communication may include means for communicating, using a first antenna panel, a first RS based at least in part on a first RS configuration, and means for communicating, simultaneously with the first RS and using a second antenna panel that is different than the first antenna panel, a second RS based at least in part on a second RS configuration, wherein the second RS configuration orthogonalizes the second RS relative to the first RS.

In some aspects, an apparatus for wireless communication may include means for communicating a first RS based at least in part on a first RS configuration, and means for communicating, simultaneously with the first RS, a second RS based at least in part on a second RS configuration, wherein the second RS configuration orthogonalizes the second RS relative to the first RS.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating examples of radio access networks, in accordance with various aspects of the present disclosure.

FIG. 4 is a diagram illustrating an example of an integrated access and backhaul (IAB) network architecture, in accordance with various aspects of the present disclosure.

FIGS. 5A-5C are diagrams illustrating examples of full duplex (FD) communication, in accordance with various aspects of the present disclosure.

FIG. 6 is a diagram illustrating an example of reference signal (RS) orthogonalization, in accordance with various aspects of the present disclosure.

FIGS. 7 and 8 are diagrams illustrating example processes associated with RS orthogonality, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technologies (RAT), aspects of the present disclosure can be applied to other RATs, such as a 3G RAT, a 4G RAT, and/or a RAT subsequent to 5G (e.g., 6G).

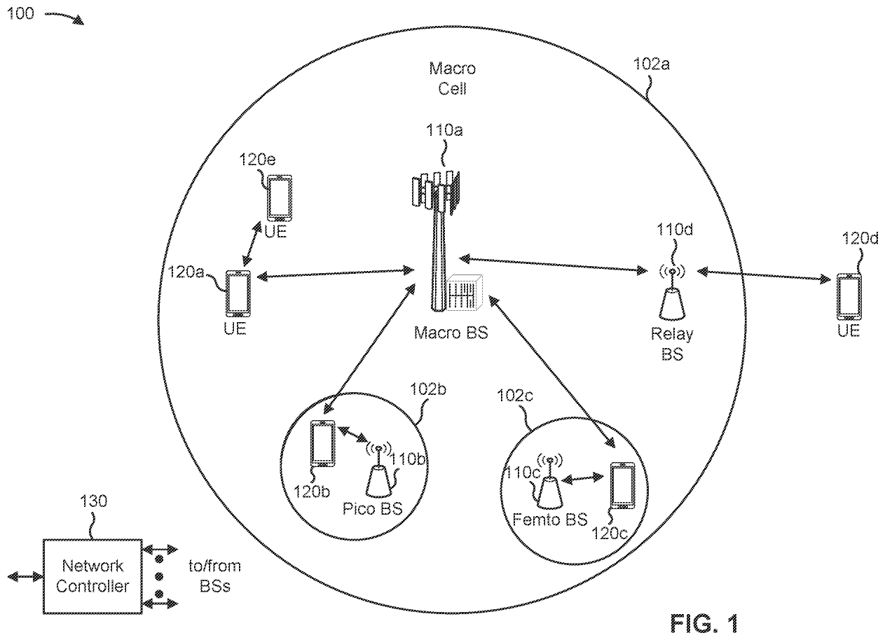

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a LTE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

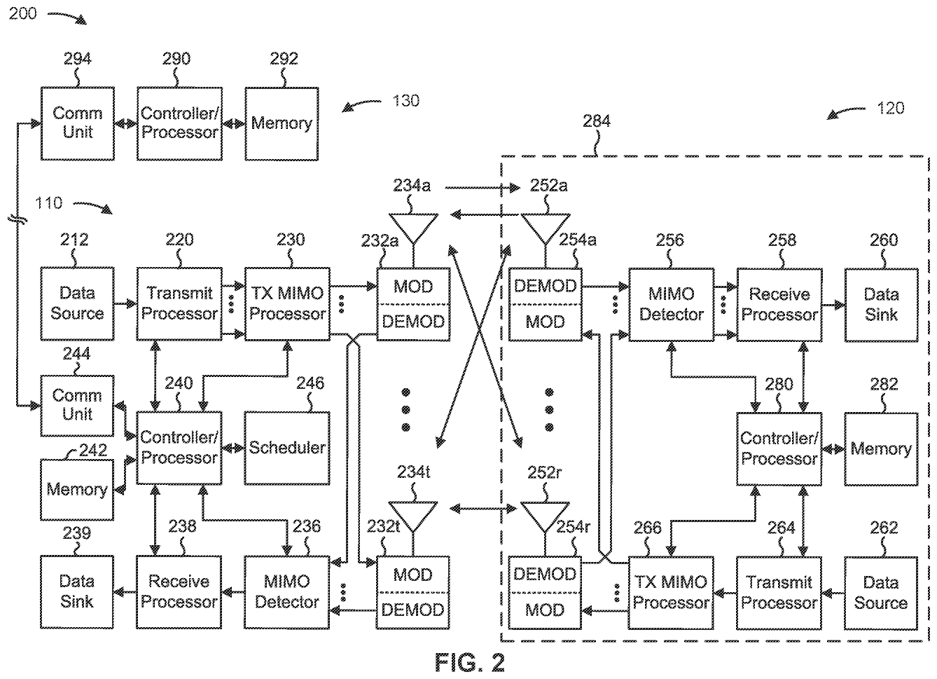

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

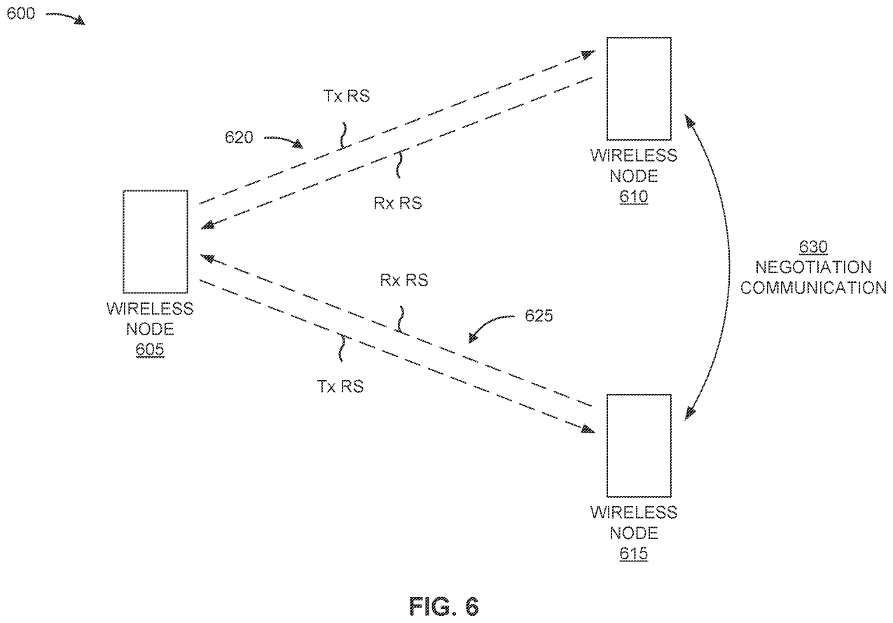

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 6-8.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 6-8.

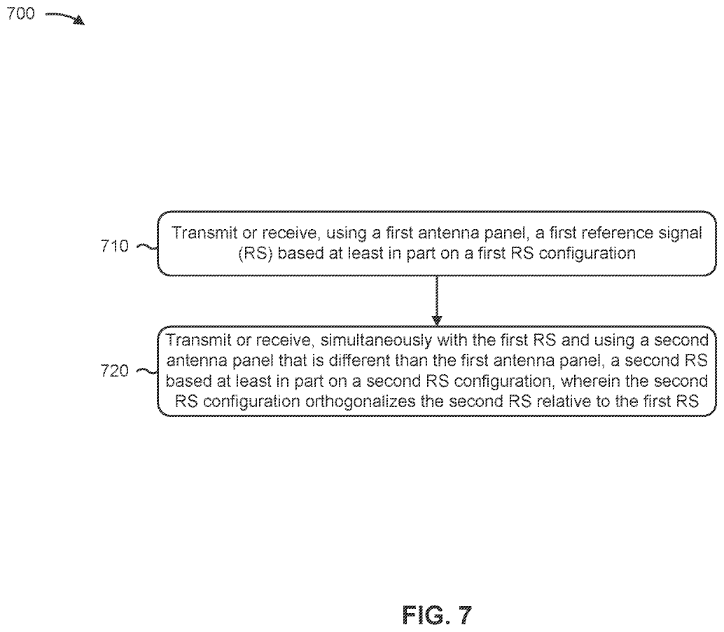

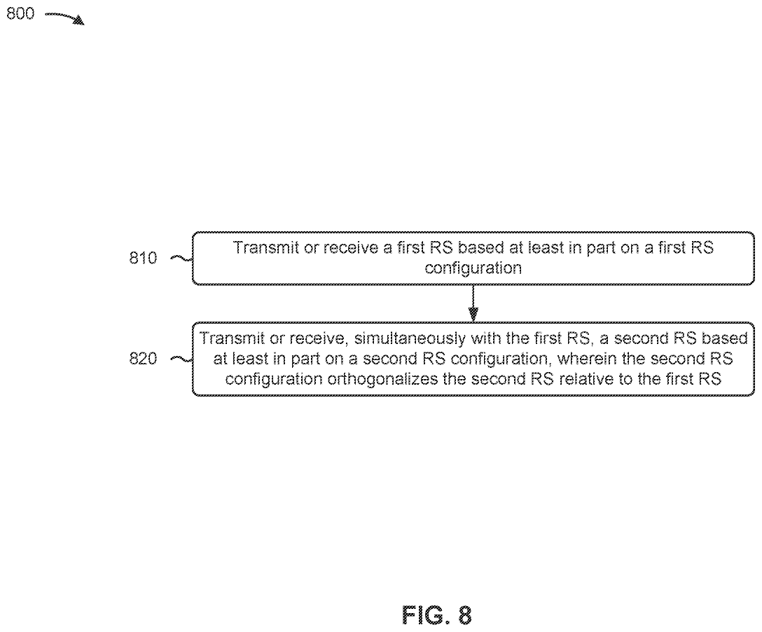

Controller/processor 240 of base station 110, controller/processor 280 of UE 120, and/or any other component(s) of FIG. 2 may perform one or more techniques associated with reference signal orthogonality, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, interpreting the instructions, and/or the like.

In some aspects, a wireless communication device (e.g., the base station 110, the UE 120, and/or the like) may include means for transmitting (e.g., using controller/processor 240, controller/processor 280, transmit processor 220, transmit processor 264, TX MIMO processor 230, TX MIMO processor 266, MOD 232, MOD 254, antenna 234, antenna 252, memory 242, memory 282, and/or the like) or receiving (e.g., using antenna 234, using antenna 252, DEMOD 232, DEMOD 254, MIMO detector 236, MIMO detector 256, receive processor 238, receive processor 258, controller/processor 240, controller/processor 280, memory 242, memory 282, and/or the like), using a first antenna panel, a first reference signal (RS) based at least in part on a first RS configuration, means for transmitting (e.g., using controller/processor 240, controller/processor 280, transmit processor 220, transmit processor 264, TX MIMO processor 230, TX MIMO processor 266, MOD 232, MOD 254, antenna 234, antenna 252, memory 242, memory 282, and/or the like) or receiving (e.g., using antenna 234, using antenna 252, DEMOD 232, DEMOD 254, MIMO detector 236, MIMO detector 256, receive processor 238, receive processor 258, controller/processor 240, controller/processor 280, memory 242, memory 282, and/or the like), simultaneously with the first RS and using a second antenna panel that is different than the first antenna panel, a second RS based at least in part on a second RS configuration, wherein the second RS configuration orthogonalizes the second RS relative to the first RS, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, an integrated access and backhaul (IAB) node (e.g., the base station 110, the UE 120, and/or the like) may include means for transmitting (e.g., using controller/processor 240, controller/processor 280, transmit processor 220, transmit processor 264, TX MIMO processor 230, TX MIMO processor 266, MOD 232, MOD 254, antenna 234, antenna 252, memory 242, memory 282, and/or the like) or receiving (e.g., using antenna 234, using antenna 252, DEMOD 232, DEMOD 254, MIMO detector 236, MIMO detector 256, receive processor 238, receive processor 258, controller/processor 240, controller/processor 280, memory 242, memory 282, and/or the like) a first reference signal (RS) based at least in part on a first RS configuration, means for transmitting (e.g., using controller/processor 240, controller/processor 280, transmit processor 220, transmit processor 264, TX MIMO processor 230, TX MIMO processor 266, MOD 232, MOD 254, antenna 234, antenna 252, memory 242, memory 282, and/or the like) or receiving (e.g., using antenna 234, using antenna 252, DEMOD 232, DEMOD 254, MEMO detector 236, MIMO detector 256, receive processor 238, receive processor 258, controller/processor 240, controller/processor 280, memory 242, memory 282, and/or the like), simultaneously with the first RS, a second RS based at least in part on a second RS configuration, wherein the second RS configuration orthogonalizes the second RS relative to the first RS, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of processor 280.

As indicated above, FIG. 2 is provided as an example. Other examples may differ from what is described with regard to FIG. 2.

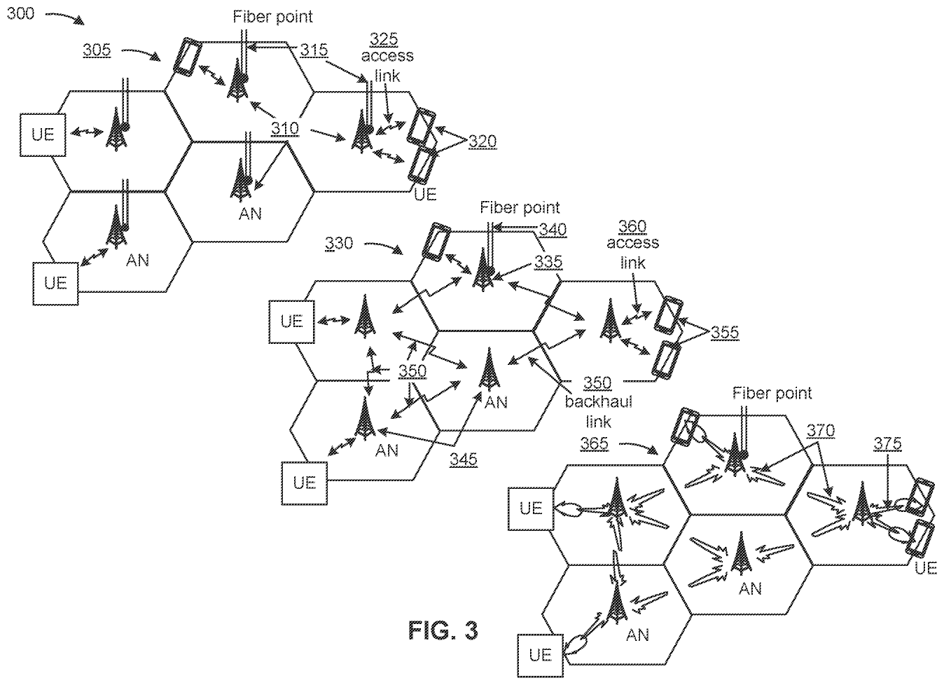

FIG. 3 is a diagram illustrating examples 300 of radio access networks, in accordance with various aspects of the disclosure.

As shown by reference number 305, a traditional (e.g., 3G, 4G, LTE, and/or the like) radio access network may include multiple base stations 310 (e.g., access nodes (AN)), where each base station 310 communicates with a core network via a wired backhaul link 315, such as a fiber connection. A base station 310 may communicate with a UE 320 via an access link 325, which may be a wireless link. In some aspects, a base station 310 shown in FIG. 3 may be a base station 110 shown in FIG. 1. In some aspects, a UE 320 shown in FIG. 3 may be a UE 120 shown in FIG. 1.

As shown by reference number 330, a radio access network may include a wireless backhaul network, sometimes referred to as an integrated access and backhaul (IAB) network. In an IAB network, at least one base station is an anchor base station 335 that communicates with a core network via a wired backhaul link 340, such as a fiber connection. An anchor base station 335 may also be referred to as an IAB donor (or IAB-donor). The IAB network may include one or more non-anchor base stations 345, sometimes referred to as relay base stations or IAB nodes (or IAB-nodes). The non-anchor base station 345 may communicate directly or indirectly with the anchor base station 335 via one or more backhaul links 350 (e.g., via one or more non-anchor base stations 345) to form a backhaul path to the core network for carrying backhaul traffic. Backhaul link 350 may be a wireless link. Anchor base station(s) 335 and/or non anchor base station(s) 345 may communicate with one or more UEs 355 via access links 360, which may be wireless links for carrying access traffic. In some aspects, an anchor base station 335 and/or a non-anchor base station 345 shown in FIG. 3 may be a base station 110 shown in FIG. 1. In some aspects, a UE 355 shown in FIG. 3 may be a UE 120 shown in FIG. 1.

As shown by reference number 365, in some aspects, a radio access network that includes an IAB network may utilize millimeter wave technology and/or directional communications (e.g., beamforming and/or the like) for communications between base stations and/or UEs (e.g., between two base stations, between two UEs, and/or between a base station and a UE). For example, wireless backhaul links 370 between base stations may use millimeter wave signals to carry information and/or may be directed toward a target base station using beamforming and/or the like. Similarly, the wireless access links 375 between a UE and a base station may use millimeter wave signals and/or may be directed toward a target wireless node (e.g., a UE and/or a base station). In this way, inter-link interference may be reduced.

The configuration of base stations and UEs in FIG. 3 is shown as an example, and other examples are contemplated. For example, one or more base stations illustrated in FIG. 3 may be replaced by one or more UEs that communicate via a UE-to-UE access network (e.g., a peer-to-peer network, a device-to-device network, and/or the like). In this case, a UE that is directly in communication with a base station (e.g., an anchor base station or a non-anchor base station) may be referred to as an anchor node.

As indicated above, FIG. 3 is provided as an example. Other examples may differ from what is described with regard to FIG. 3.

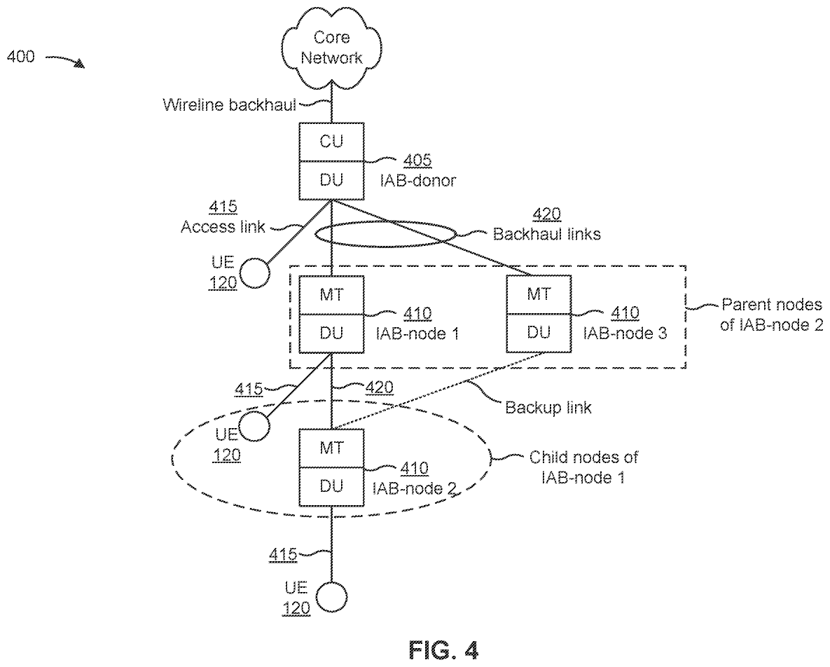

FIG. 4 is a diagram illustrating an example 400 of an IAB network architecture, in accordance with various aspects of the disclosure.

As shown in FIG. 4, an IAB network may include an IAB donor 405 (shown as IAB-donor) that connects to a core network via a wired connection (shown as a wireline backhaul). For example, an Ng interface of an IAB donor 405 may terminate at a core network. Additionally, or alternatively, an IAB donor 405 may connect to one or more devices of the core network that provide a core access and mobility management function (e.g., AMF). In some aspects, an IAB donor 405 may include a base station 110, such as an anchor base station, as described above in connection with 3. As shown, an IAB donor 405 may include a central unit (CU), which may perform access node controller (ANC) functions, AMF functions, and/or the like. The CU may configure a distributed unit (DU) of the IAB donor 405 and/or may configure one or more IAB nodes 410 (e.g., an MT and/or a DU of an IAB node 410) that connect to the core network via the IAB donor 405. Thus, a CU of an IAB donor 405 may control and/or configure the entire IAB network that connects to the core network via the IAB donor 405, such as by using control messages and/or configuration messages (e.g., a radio resource control (RRC) configuration message, an F1 application protocol (F1AP) message, and/or the like).

As further shown in FIG. 4, the IAB network may include IAB nodes 410 (shown as IAB-node 1, IAB-node 2, and lAB-node 3) that connect to the core network via the IAB donor 405. As shown, an lAB node 410 may include mobile termination (MT) functions (also sometimes referred to as UE functions (UEF)) and may include DU functions (also sometimes referred to as access node functions (ANF)). The MT functions of an IAB node 410 (e.g., a child node) may be controlled and/or scheduled by another IAB node 410 (e.g., a parent node of the child node) and/or by an IAB donor 405. The DU functions of an IAB node 410 (e.g., a parent node) may control and/or schedule other IAB nodes 410 (e.g., child nodes of the parent node) and/or UEs 120. Thus, a DU may be referred to as a scheduling node or a scheduling component, and an MT may be referred to as a scheduled node or a scheduled component. In some aspects, an IAB donor 405 may include DU functions and not MT functions. That is, an IAB donor 405 may configure, control, and/or schedule communications of IAB nodes 410 and/or UEs 120. A UE 120 may include only MT functions, and not DU functions. That is, communications of a UE 120 may be controlled and/or scheduled by an 1AB donor 405 and/or an lAB node 410 (e.g., a parent node of the UE 120).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an lAB donor 405 or an IAB node 410, and a child node may be an IAB node 410 or a UE 120. Communications of an MT function of a child node may be controlled and/or scheduled by a parent node of the child node.

As further shown in FIG. 4, a link between a UE 120 (e.g., which only has MT functions, and not DU functions) and an IAB donor 405, or between a UE 120 and an IAB node 410, may be referred to as an access link 415. Access link 415 may be a wireless access link that provides a UE 120 with radio access to a core network via an lAB donor 405, and optionally via one or more IAB nodes 410. Thus, the network illustrated in 4 may be referred to as a multi-hop network or a wireless multi-hop network.

As further shown in FIG. 4, a link between an IAB donor 405 and an IAB node 410 or between two IAB nodes 410 may be referred to as a backhaul link 420. Backhaul link 420 may be a wireless backhaul link that provides an IAB node 410 with radio access to a core network via an lAB donor 405, and optionally via one or more other lAB nodes 410. In an IAB network, network resources for wireless communications (e.g., time resources, frequency resources, spatial resources, and/or the like) may be shared between access links 415 and backhaul links 420. In some aspects, a backhaul link 420 may be a primary backhaul link or a secondary backhaul link (e.g., a backup backhaul link). In some aspects, a secondary backhaul link may be used if a primary backhaul link fails, becomes congested, becomes overloaded, and/or the like. For example, a backup link 425 between IAB-node 2 and IAB-node 3 may be used for backhaul communications if a primary backhaul link between IAB-node 2 and lAB-node 1 fails. As used herein, an IAB donor 405 or an IAB node 410 may be referred to as a node or a wireless node.

As indicated above, FIG. 4 is provided as an example. Other examples may differ from what is described with regard to FIG. 4.

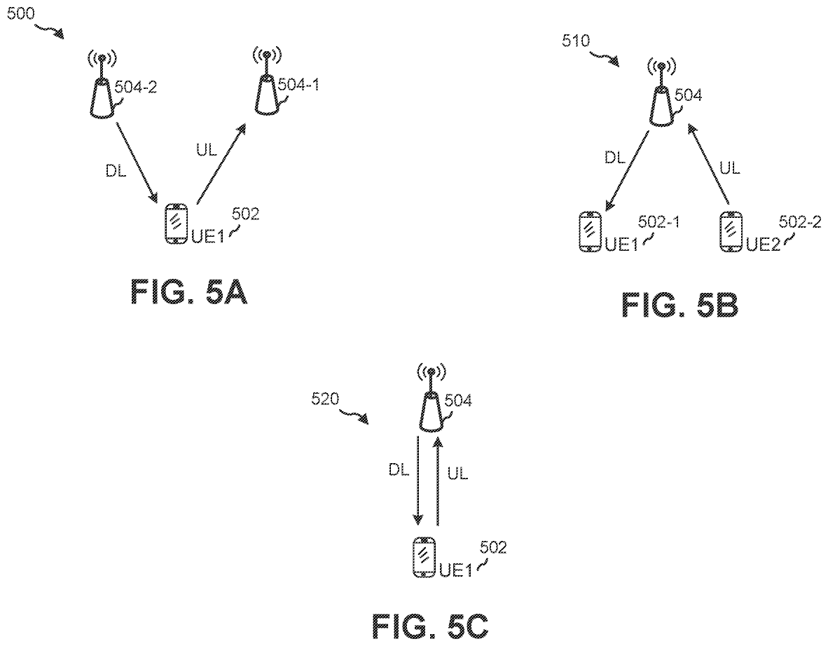

FIGS. 5A-5C are diagrams illustrating examples 500, 510, 520 of full duplex (FD) communication. The example 500 of FIG. 5A includes a UE1 502 and two base stations (e.g., TRPs) 504-1, 504-2, wherein the UE1 502 is sending UL transmissions to base station 504-1 and is receiving DL transmissions from base station 504-2. In the example 500 of FIG. 5A, FD is enabled for the UEI 502, but not for the base stations 504-1, 504-2. The example 510 of FIG. 5B includes two UEs, UE1 502-1 and UE2 502-2, and a base station 504, wherein the UE1 502-1 is receiving a DL transmission from the base station 504 and the UE2 502-2 is transmitting a UL transmission to the base station 504. In the example 510 of FIG. 5B, FD is enabled for the base station 504, but not for the UEs UEI 502-1 and UE2 502-2. The example 520 of FIG. 5C includes a UE1 502 and a base station 504, wherein the UE1 502 is receiving a DL transmission from the base station 504 and the UE1 502 is transmitting a UL transmission to the base station 504. In the example 520 of FIG. 5C, FD is enabled for both the UE1 502 and the base station 504.

As indicated above, FIGS. 5A-5C are provided as one or more examples. Other examples may differ from what is described with regard to FIGS. 5A-5C.

The present disclosure generally relates to improving the manner in which RS orthogonality operates to allow for FD communication, simultaneous receive (Rx)/transmit (Tx) communication in UE-BS networks, and/or IAB networks, and/or the like. For example, for a wireless node, transmission may be performed using one antenna panel and reception may be performed using another antenna panel. FD communication and/or simultaneous Rx/Tx communication may be conditional on a beam separation of the Tx (e.g., UL and/or the like) beam and Rx (e.g., DL and/or the like) beam at the respective antenna panels. Simultaneous communication (e.g., simultaneous Rx, simultaneous Tx, and/or the like) refers to two or more communications (transmissions and/or receptions) that occur simultaneously, contemporaneously, or with at least some overlap in the time domain.

According to a wireless communication standard related to demodulation reference signals (DMRSs), a UE may be configured by a higher layer parameter (e.g., represented by the parameter PDCCH-Config) that contains two different values of a control resource set (CORESET) pool index (e.g., represented by the parameter CORESETPoolIndex) in a CORESET (e.g., represented by the parameter ControlResourceSet). The UE may be scheduled with fully or partially overlapping physical downlink shared channels (PDSCHs) in the time and frequency domain by multiple physical downlink control channels (PDCCHs). This type of scheduling may be subject to a number of restrictions associated with RSs.

For example, the UE may not be expected to assume different DMRS configurations with respect to an actual number of front-loaded DMRS symbols, an actual number of additional DMRS symbols, an actual DMRS symbol location, a DMRS configuration type, and/or the like. The UE may not be expected to assume DMRS ports in a code division multiplex (CDM) group indicated by two transmission configuration indicator (TCI) states. In multiple transmission and reception (mTRP) architectures, a PDSCH communication from different TRPs may have the same actual number of DMRS symbols, the same actual DMRS symbol location, the same DMRS configuration type, and/or the like. Restrictions and configurations such as those described above may be extended to FD transmission mode, multiple Rx/Tx communication in UE-BS networks, and/or IAB networks, and/or the like. Additionally, similar concepts may be extended to other types of RSs, such as DL and UL phase tracking reference signals (PTRSs).

In some aspects, for example, if DMRS configurations in DL and UL are the same, for the same DMRS port index in DL and UL, the DMRS resource element (RE) positions in a resource block (RB) may be the same. For example, DL DMRS port 1 REs are the same as UL DMRS port 1 REs and may be extended to be the same for all of the DMRS ports where the provided DMRS configuration type is the same for DL and UL. This may result in cross-link interference, which may reduce reliable reception of DMRSs, which may result in decreased communication quality, latency, and/or the like.

Aspects of the techniques and apparatuses described herein may facilitate ensuring RS orthogonality during FD communications, multiple Tx/Rx communications in UE-BS networks, and/or IAB networks, and/or the like. As a result, cross-link interference of RSs may be reduced, thereby enhancing reception of RSs, which may result in increased communication quality, decreased latency, and/or the like.

FIG. 6 is a diagram illustrating an example 600 associated with reference signal (RS) orthogonalization, in accordance with various aspects of the present disclosure. As shown in FIG. 6, example 600 includes a first wireless node 605, a second wireless node 610, and a third wireless node 615. The first wireless node 605, the second wireless node 610, and/or the third wireless node 615 may comprise any type of wireless node, wireless communication device, a UE (e.g., UE 120), a base station (e.g., base station 110), an IAB node (e.g., IAB node 345), and/or the like.

For example, in some aspects, the wireless node 605 may include a UE, the wireless node 610 may include a first TRP, and the wireless node 615 may include a second TRP. In some aspects, the wireless node 605 may include a base station, the wireless node 610 may include a first UE, and the wireless node 615 may include a second UE. In some aspects, the wireless node 605 may include an IAB node, the wireless node 610 may include a parent node, and the wireless node 615 may include a child node. In some aspects, the wireless node 605 may include an IAB node, the wireless node 610 may include a first parent node, and the wireless node 615 may include a second parent node.

As shown by reference number 620, the wireless node 605 may communicate a first RS. Throughout this disclosure, “communicate” means “transmit,” “receive,” or a combination thereof. For example, as shown by reference number 620, the wireless node 605 may transmit and/or receive a first RS. In some aspects, the communication of the first RS may be based at least in part on a first RS configuration. As shown by reference number 625, the wireless node 605 may communicate a second RS. In some aspects, the communication of the second RS may be based at least in part on a second RS configuration. In some aspects, the second RS configuration may orthogonalize the second RS relative to the first RS. In this way, aspects of the techniques described herein may facilitate reducing interference between RSs. In some aspects, the first RS may be transmitted or received using a first antenna panel and the second RS may be transmitted or received using a second antenna panel.

According to various aspects, a received RS (e.g., an Rx RS, a DL RS, and/or the like) may include a DL DMRS, a tracking reference signal (TRS), a DL phase TRS, a channel state information RS (CSI-RS), and/or the like. In some aspects, a transmitted RS (e.g., a Tx RS, a UL RS, and/or the like) may include a UL DMRS, a UL sounding reference signal (SRS), a UL phase TRS, and/or the like.

In some aspects, based at least in part on the first RS comprising an RS type that matches an RS type of the second RS, the first RS configuration may associate the first RS with a first code division multiplexing (CDM) group and the second RS configuration may associate the second RS with a second CDM group. The first CDM group and the second CDM group may have RS orthogonality relative to one another. In some aspects, based at least on the first RS comprising an RS type that is different than an RS type of the second RS, the first RS configuration may associate the first RS with a first set of REs and the second RS configuration may associate the second RS with a second set of REs. The first set of REs and the second set of REs may have RS orthogonality relative to one another.

In some aspects, the wireless node 605 may include a UE (e.g., UE 120) and the wireless nodes 610 and 615 may include TRPs, base stations (e.g., base station 110), and/or the like. In some aspects, the wireless node 605 may receive the first RS configuration and the second RS configuration. In some aspects, one or more of the wireless nodes 610 and 615 may transmit the first RS configuration and the second RS configuration. In some aspects, the wireless node 605 may transmit an RS orthogonality request. The first RS configuration, the second RS configuration, and/or a combination thereof may be based at least in part on the RS orthogonality request.

In some aspects, the wireless node 605 may receive scheduled allocations that schedule simultaneous full duplex communications based at least in part on a PDSCH and a PUSCH. In some aspects, the wireless node 605 may not be configured to assume different RS configurations in DL and UL with respect to an actual number of front-loaded RS symbols, an actual number of additional RS symbols, an actual RS symbol location, an RS configuration type, and/or the like.

In various aspects described below, the first RS configuration may associate the first RS with a first CDM group. The second RS configuration may associate the second RS with a second CDM group. The first CDM group may be orthogonal to the second CDM group. In some aspects, the first RS configuration may associate the first CDM group with one of UL communications or DL communications in a full duplex transmission mode. In some aspects, the second RS configuration may associate the second CDM group with the other one of UL communications or DL communications.

In some aspects, the wireless node 605 may include a base station (e.g., base station 110) and the wireless nodes 610 and 615 may include UEs (e.g., UE 120), and/or the like. In some aspects, the wireless node 605 (e.g., base station) may transmit the first RS configuration and the second RS configuration to one or more other wireless nodes 610, 615 (e.g., UEs). In some aspects, the wireless node 605 may transmit scheduling allocations that schedule simultaneous full duplex communications based at least in part on a PDSCH and a PUSCH.

In some aspects, the first RS may correspond to a first RS port and the second RS may correspond to a second RS port. The first RS port may be associated with the first CDM group and the second RS port may be associated with the second CDM group.

In some aspects, the wireless node 605 may include an IAB node (e.g., IAB node 345) and the wireless nodes 610 and 615 may include child nodes, parent nodes, and/or the like.

In some aspects, communicating the first RS may include receiving the first RS from a parent node of the IAB node 610 and communicating the second RS may include receiving the second RS from one or more child nodes 615 of the IAB node 605. In some aspects, communicating the first RS may include transmitting the first RS to a parent node 610 of the IAB node and communicating the second RS may include receiving the second RS from one or more child nodes 615 of the IAB node 605. In some aspects, communicating the first RS may include transmitting the first RS to a parent node 610 of the IAB node 605 and communicating the second RS may include transmitting the second RS to one or more child nodes 615 of the IAB node 605. In some aspects, communicating the first RS may include receiving the first RS from a parent node 610 of the IAB node and communicating the second RS may include transmitting the second RS to one or more child nodes 615 of the IAB node 605.

In some aspects, the IAB node 605 may transmit an RS orthogonality request. The first RS configuration, the second RS configuration, and/or the like may be based at least in part on the RS orthogonality request. In some aspects, the IAB node 605 may receive the first RS configuration and the second RS configuration from a parent node 610 of the IAB node 605. In some aspects, the IAB node 605 may receive the first RS configuration, the second RS configuration, and/or the like from a central unit (CU) of the multi-hop IAB network.

In some aspects, the IAB node 605 may provide the first RS configuration, the second RS configuration, and/or the like to at least one child node 615 of the IAB node 605. In some aspects, the IAB node 605 may receive an RS orthogonality request. The first RS configuration, the second RS configuration, and/or the like may be based at least in part on the RS orthogonality request. In some aspects, the first RS configuration, the second RS configuration, and/or the like may be based at least in part on a negotiation communication between the IAB node 605 and a parent node 610 of the IAB node.

In some aspects, the IAB node 605 may transmit scheduling allocations that schedule simultaneous full duplex communications, simultaneous transmissions to a parent node and a child node, simultaneous receptions from a parent node and a child node, and/or the like based at least in part on a PDSCH and a PUSCH, two PDSCHs, two PUSCHs, and/or the like. In some aspects, the IAB node 605 may receive scheduling allocations that schedule simultaneous full duplex communications, simultaneous transmissions to a parent node and a child node, simultaneous receptions from a parent node and a child node, and/or the like based at least in part on a PDSCH and a PUSCH, two PDSCHs, two PUSCHs, and/or the like. In some aspects, the first RS configuration may associate the first CDM group with one of UL communications or DL communications in a simultaneous Tx mode and the second RS configuration may associate the second CDM group with the other one of UL communications or DL communications in a simultaneous Tx mode. In some aspects, the first RS configuration may associate the first CDM group with one of UL communications or DL communications in a simultaneous Rx mode and the second RS configuration may associate the second CDM group with the other one of UL communications or DL communications in a simultaneous Rx mode. In some aspects, the first RS may correspond to a first RS port and the second RS may correspond to a second RS port. The first RS port may be associated with the first CDM group and the second RS port may be associated with the second CDM group.

In some aspects, the wireless node 605 may include an MT of an IAB node (e.g., IAB node 410), and the wireless nodes 610 and 615 may include parent IAB nodes of the IAB node, and/or the like. In some aspects, the MT may be in concurrent communication with a first parent node 610 of the IAB node and a second parent node 615 of the IAB node.

In some aspects, communicating the first RS may include receiving the first RS from the first parent node 610 of the MT 605 and communicating the second RS may include receiving the second RS from the second parent node 615 of the MT 605. In some aspects, communicating the first RS may include transmitting the first RS to the first parent node 610 of the MT 605 and communicating the second RS comprises transmitting the second RS to the second parent node 615 of the MT 605. In some aspects, communicating the first RS may include receiving the first RS from the first parent node 610 of the MT 605 and communicating the second RS may include transmitting the second RS to the second parent node 615 of the MT 605. In some aspects, communicating the first RS may include transmitting the first RS to the first parent node 610 of the MT 605 and communicating the second RS may include receiving the second RS from the second parent node 615 of the MT 605.

In some aspects, the MT 605 may transmit an RS orthogonality request. In some aspects, the first RS configuration, the second RS configuration, and/or the like may be based at least in part on the RS orthogonality request. In some aspects, the MT 605 may receive the first RS configuration and the second RS configuration.

In some aspects, the MT 605 may receive the first RS configuration from the first parent node 610 of the MT 605 and may transmit an indication of the first RS configuration to the second parent node 615 of the IAB. The indication may be to facilitate selection of the second RS configuration by the second parent node 615 of the MT 605. In some aspects, the MT 605 may receive the first RS configuration, the second RS configuration, and/or the like from a CU of the multi-hop IAB network.

In some aspects, the MT 605 may transmit a proposed first RS configuration and a proposed second RS configuration to the first parent node 610 of the IAB. The MT 605 also may transmit the proposed first RS configuration and the proposed second RS configuration to the second parent node 615 of the IAB. The first RS configuration, the second RS configuration, and/or the like may be based at least in part on at least one of the proposed first RS configuration, the proposed second RS configuration, and/or the like.

In some aspects, the MT 605 may receive scheduling allocations that schedule simultaneous full duplex communications, simultaneous transmissions to two parent nodes, simultaneous receptions from two parent nodes, and/or the like based at least in part on a PDSCH and a PUSCH, two PDSCHs, two PUSCHs, and/or the like. The first RS configuration may associate the first CDM group with one of UL communications or DL communications in a full duplex transmission mode. In some aspects, the second RS configuration may associate the second CDM group with the other one of UL communications or DL communications. In some aspects, the first RS configuration may associate the first CDM group with one of UL communications or DL communications in a simultaneous Tx mode and the second RS configuration may associate the second CDM group with the other one of UL communications or DL communications in a simultaneous Tx mode. In some aspects, the first RS configuration may associate the first CDM group with one of UL communications or DL communications in a simultaneous Rx mode and the second RS configuration may associate the second CDM group with the other one of UL communications or DL communications in a simultaneous Rx mode. In some aspects, the first RS corresponds to a first RS port and the second RS corresponds to a second RS port. The first RS port may be associated with the first CDM group and the second RS port may be associated with the second CDM group.

In some aspects, the MT 605 may receive the first RS configuration, the second RS configuration, and/or the like from the first parent node 610 of the MT 605. As shown by reference 630, the communication with the second parent node 615 of the MT 605 may be based at least in part on a negotiation communication between the first parent node 610 of the MT 605 and the second parent node 615 of the MT 605.

As indicated above, FIG. 6 is provided as an example. Other examples may differ from what is described with respect to FIG. 6.

FIG. 7 is a diagram illustrating an example process 700 performed, for example, by a wireless node, in accordance with various aspects of the present disclosure. Example process 700 is an example where the wireless node (e.g., base station 110, UE 120, and/or the like) performs operations associated with reference signal orthogonality. In some aspects, the wireless node may include the UE1 502 depicted in FIG. 5A, the base station 504 depicted in FIG. 5B, the UE1 502 depicted in FIG. 5C, the base station 504 depicted in FIG. 5C, and/or the like. In some aspects, the wireless node may include the first wireless node 605 depicted in FIG. 6.

As shown in FIG. 7, in some aspects, process 700 may include communicating (transmitting or receiving), using a first antenna panel, a first RS based at least in part on a first RS configuration (block 710). For example, a wireless node (e.g., using transmit processor 220, transmit processor 264, receive processor 238, receive processor 258, controller/processor 240, controller/processor 280, memory 242, memory 282, and/or the like) may communicate, using a first antenna panel, a first RS based at least in part on a first RS configuration, as described above, for example, with reference to FIG. 6.

As further shown in FIG. 7, in some aspects, process 700 may include communicating, simultaneously with the first RS and using a second antenna panel that is different than the first antenna panel, a second RS based at least in part on a second RS configuration, wherein the second RS configuration orthogonalizes the second RS relative to the first RS (block 720). For example, the wireless node (e.g., using transmit processor 220, transmit processor 264, receive processor 238, receive processor 258, controller/processor 240, controller/processor 280, memory 242, memory 282, and/or the like) may communicate, simultaneously with the first RS and using a second antenna panel that is different than the first antenna panel, a second RS based at least in part on a second RS configuration, as described above, for example, with reference to FIG. 6. In some aspects, the second RS configuration orthogonalizes the second RS relative to the first RS.

Process 700 may include additional aspects, such as any single aspect or any combination of aspects described below and/or in connection with one or more other processes described elsewhere herein.

In a first aspect, the wireless node is a base station, and process 700 includes transmitting scheduling allocations that schedule simultaneous full duplex communications based at least in part on at least one of a PDSCH, a PUSCH, or a combination thereof.

In a second aspect, alone or in combination with the first aspect, the wireless node is a UE, and process 700 includes receiving scheduling allocations that schedule simultaneous full duplex communications based at least in part on at least one of a PDSCH, a PUSCH, or a combination thereof.

In a third aspect, alone or in combination with one or more of the first and second aspects, the first RS configuration associates the first RS with a first CDM group, the second RS configuration associates the second RS with a second CDM group, and the first CDM group is orthogonal to the second CDM group.

In a fourth aspect, alone or in combination with one or more of the first through third aspects, the first RS configuration associates the first CDM group with one of UL communications or DL communications in a full duplex transmission mode, a simultaneous transmission mode, or a simultaneous reception mode, and the second RS configuration associates the second CDM group with one other of the UL communications or the DL communications.

In a fifth aspect, alone or in combination with one or more of the first through fourth aspects, the first RS corresponds to a first RS port, the second RS corresponds to a second RS port, the first RS port is associated with the first CDM group, and the second RS port is associated with the second CDM group.

In a sixth aspect, alone or in combination with one or more of the first through fifth aspects, the wireless node is a base station.

In a seventh aspect, alone or in combination with one or more of the first through sixth aspects, process 700 includes transmitting the first RS configuration and the second RS configuration.

In an eighth aspect, alone or in combination with one or more of the first through seventh aspects, communicating the first RS comprises transmitting, in a DL, the first RS to a first UE, and communicating the second RS comprises simultaneously receiving, in a UL, the second RS from a second UE.

In a ninth aspect, alone or in combination with one or more of the first through eighth aspects, communicating the first RS comprises transmitting, in a DL, the first RS to a UE, and communicating the second RS comprises simultaneously receiving, in a UL, the second RS from the UE.

In a tenth aspect, alone or in combination with one or more of the first through ninth aspects, the first RS comprises a DL RS corresponding to a resource set and the second RS comprises a UL RS corresponding to the resource set.

In an eleventh aspect, alone or in combination with one or more of the first through tenth aspects, the DL RS comprises a DL DMRS, a TRS, a DL phase TRS, or a CSI-RS.

In a twelfth aspect, alone or in combination with one or more of the first through eleventh aspects, the UL RS comprises a UL DMRS, a UL SRS, or a UL phase TRS.

In a thirteenth aspect, alone or in combination with one or more of the first through twelfth aspects, the wireless node is a UE.

In a fourteenth aspect, alone or in combination with one or more of the first through thirteenth aspects, process 700 includes receiving the first RS configuration and the second RS configuration.

In a fifteenth aspect, alone or in combination with one or more of the first through fourteenth aspects, communicating the first RS comprises receiving, in a DL, the first RS from a first base station, and communicating the second RS comprises simultaneously transmitting, in a UL, the second RS to a second base station.

In a sixteenth aspect, alone or in combination with one or more of the first through fifteenth aspects, communicating the first RS comprises receiving, in a DL, the first RS from a base station, and communicating the second RS comprises simultaneously transmitting, in a UL, the second RS to the base station.

In a seventeenth aspect, alone or in combination with one or more of the first through sixteenth aspects, the first RS comprises a DL RS corresponding to a resource set and the second RS comprises a UL RS corresponding to the resource set.

In an eighteenth aspect, alone or in combination with one or more of the first through seventeenth aspects, the DL RS comprises a DL DMRS, a TRS, a DL phase TRS, or a CSI-RS.

In a nineteenth aspect, alone or in combination with one or more of the first through eighteenth aspects, the UL RS comprises a UL DMRS, a UL SRS, or a UL phase TRS.

In a twentieth aspect, alone or in combination with one or more of the first through nineteenth aspects, the wireless node is a UE, and process 700 includes transmitting an RS orthogonality request, wherein at least one of the first RS configuration, the second RS configuration, or a combination thereof, is based at least in part on the RS orthogonality request.

In a twenty-first aspect, alone or in combination with one or more of the first through twentieth aspects, the wireless node is a base station, and process 700 includes receiving an RS orthogonality request, wherein at least one of the first RS configuration, the second RS configuration, or a combination thereof, is based at least in part on the RS orthogonality request.

In a twenty-second aspect, alone or in combination with one or more of the first through twenty-first aspects, based, at least in part on the first RS comprising an RS type that matches an RS type of the second RS, the first RS configuration associates the first RS with a first CDM group and the second RS configuration associates the second RS with a second CDM group, wherein the first CDM group and the second CDM group have RS orthogonality relative to one another.

In a twenty-third aspect, alone or in combination with one or more of the first through twenty-second aspects, based at least on the first RS comprising an RS type that is different than an RS type of the second RS, the first RS configuration associates the first RS with a first set of REs and the second RS configuration associates the second RS with a second set of REs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by an IAB node, in accordance with various aspects of the present disclosure. Example process 800 is an example where the IAB node (e.g., base station 110, UE 120, IAB node 410, and/or the like) performs operations associated with reference signal orthogonality. In some aspects, the IAB node may include the anchor base station 335 depicted in FIG. 3, a non-anchor base station 345 depicted in FIG. 3, a UE 355 depicted in FIG. 3, and/or the like. In some aspects, the IAB node may include the IAB donor 405 depicted in FIG. 4, an IAB node 410 depicted in FIG. 4, an MT function of an IAB node 410 depicted in FIG. 4, a DU function of an IAB node 410 depicted in FIG. 4, and/or the like. In some aspects, the IAB node may include the first wireless node 605 depicted in FIG. 6.

As shown in FIG. 8, in some aspects, process 800 may include communicating (transmitting or receiving) a first RS based at least in part on a first RS configuration (block 810). For example, the IAB node (e.g., using transmit processor 220, transmit processor 264, receive processor 238, receive processor 258, controller/processor 240, controller/processor 280, memory 242, memory 282, and/or the like) may communicate a first RS based at least in part on a first RS configuration, as described above, for example, with reference to FIG. 6.

As further shown in FIG. 8, in some aspects, process 800 may include communicating (transmitting or receiving), simultaneously with the first RS, a second RS based at least in part on a second RS configuration, wherein the second RS configuration orthogonalizes the second RS relative to the first RS (block 820). For example, the IAB node (e.g., using transmit processor 220, transmit processor 264, receive processor 238, receive processor 258, controller/processor 240, controller/processor 280, memory 242, memory 282, and/or the like) may communicate, simultaneously with the first RS, a second RS based at least in part on a second RS configuration, as described above, for example, with reference to FIG. 6. In some aspects, the second RS configuration orthogonalizes the second RS relative to the first RS.

Process 800 may include additional aspects, such as any single aspect or any combination of aspects described below and/or in connection with one or more other processes described elsewhere herein.

In a first aspect, the first RS configuration associates the first RS with a first CDM group, and the second RS configuration associates the second RS with a second CDM group, where the first CDM group is orthogonal to the second CDM group.

In a second aspect, alone or in combination with the first aspect, the first RS configuration associates the first CDM group with one of UL communications or DL communications in a full duplex transmission mode, a simultaneous transmission mode, or a simultaneous reception mode, and the second RS configuration associates the second CDM group with one other of the UL communications or the DL communications.

In a third aspect, alone or in combination with one or more of the first and second aspects, the first RS corresponds to a first RS port, the second RS corresponds to a second RS port, the first RS port is associated with the first CDM group, and the second RS port is associated with the second CDM group.

In a fourth aspect, alone or in combination with one or more of the first through third aspects, communicating the first RS comprises receiving the first RS from a parent node of the IAB node, and communicating the second RS comprises simultaneously receiving the second RS from one or more child nodes of the IAB node.

In a fifth aspect, alone or in combination with one or more of the first through fourth aspects, communicating the first RS comprises transmitting the first RS to a parent node of the IAB node, and communicating the second RS comprises simultaneously receiving the second RS from one or more child nodes of the IAB node.

In a sixth aspect, alone or in combination with one or more of the first through fifth aspects, communicating the first RS comprises transmitting the first RS to a parent node of the IAB node, and communicating the second RS comprises simultaneously transmitting the second RS to one or more child nodes of the IAB node.

In a seventh aspect, alone or in combination with one or more of the first through sixth aspects, communicating the first RS comprises receiving the first RS from a parent node of the IAB node, and communicating the second RS comprises simultaneously transmitting the second RS to one or more child nodes of the IAB node.

In an eighth aspect, alone or in combination with one or more of the first through seventh aspects, process 800 includes receiving at least one of the first RS configuration, the second RS configuration, or a combination thereof from a parent node of the IAB node.

In a ninth aspect, alone or in combination with one or more of the first through eighth aspects, process 800 includes providing at least one of the first RS configuration, the second RS configuration, or a combination thereof to at least one child node of the IAB node.

In a tenth aspect, alone or in combination with one or more of the first through ninth aspects, process 800 includes receiving at least one of the first RS configuration, the second RS configuration, or a combination thereof from a central unit of the multi-hop IAB network.

In an eleventh aspect, alone or in combination with one or more of the first through tenth aspects, at least one of the first RS configuration, the second RS configuration, or a combination thereof is based at least in part on a negotiation communication between the IAB node and a parent node of the IAB node.

In a twelfth aspect, alone or in combination with one or more of the first through eleventh aspects, the IAB node comprises an MT function in concurrent communication with a first parent node of the IAB node and a second parent node of the IAB node.

In a thirteenth aspect, alone or in combination with one or more of the first through twelfth aspects, communicating the first RS comprises receiving the first RS from the first parent node of the IAB node, and communicating the second RS comprises simultaneously receiving the second RS from the second parent node of the IAB node.

In a fourteenth aspect, alone or in combination with one or more of the first through thirteenth aspects, communicating the first RS comprises transmitting the first RS to the first parent node of the IAB node, and communicating the second RS comprises simultaneously transmitting the second RS to the second parent node of the IAB node.

In a fifteenth aspect, alone or in combination with one or more of the first through fourteenth aspects, communicating the first RS comprises receiving the first RS from the first parent node of the IAB node, and communicating the second RS comprises simultaneously transmitting the second RS to the second parent node of the IAB node.

In a sixteenth aspect, alone or in combination with one or more of the first through fifteenth aspects, communicating the first RS comprises transmitting the first RS to the first parent node of the IAB node, and communicating the second RS comprises simultaneously receiving the second RS from the second parent node of the IAB node.

In a seventeenth aspect, alone or in combination with one or more of the first through sixteenth aspects, process 800 includes receiving at least one of the first RS configuration, the second RS configuration, or a combination thereof from the first parent node of the IAB, where the communication with the second parent node of the IAB is based at least in part on a negotiation communication between the first parent node of the IAB and the second parent node of the IAB.

In an eighteenth aspect, alone or in combination with one or more of the first through seventeenth aspects, process 800 includes receiving the first RS configuration from the first parent node of the IAB and transmitting an indication of the first RS configuration to the second parent node of the IAB, where the indication is to facilitate selection of the second RS configuration by the second parent node of the IAB.

In a nineteenth aspect, alone or in combination with one or more of the first through eighteenth aspects, process 800 includes receiving at least one of the first RS configuration, the second RS configuration, or a combination thereof from a CU of the multi-hop IAB network.

In a twentieth aspect, alone or in combination with one or more of the first through nineteenth aspects, process 800 includes transmitting a proposed first RS configuration and a proposed second RS configuration to the first parent node of the IAB; and transmitting the proposed first RS configuration and the proposed second RS configuration to the second parent node of the IAB, where at least one of the first RS configuration, the second RS configuration, or a combination thereof is based at least in part on at least one of the proposed first RS configuration, the proposed second RS configuration, or a combination thereof.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a wireless node in a wireless communication network, the method comprising:
communicating, using a first antenna panel, a first reference signal (RS) based at least in part on a first RS configuration, and
communicating, simultaneously with the first RS and using a second antenna panel that is different than the first antenna panel, a second RS based at least in part on a second RS configuration, wherein the second RS configuration orthogonalizes the second RS relative to the first RS.

2. The method of claim 1, wherein the wireless node is a base station, the method further comprising transmitting scheduling allocations that schedule simultaneous full duplex communications based at least in part on at least one of a physical downlink shared channel (PDSCH), a physical uplink shared channel (PUSCH), or a combination thereof.

3. The method of claim 1, wherein the wireless node is a user equipment (UE), the method further comprising receiving scheduling allocations that schedule simultaneous full duplex communications based at least in part on at least one of a physical downlink shared channel (PDSCH), a physical uplink shared channel (PUSCH), or a combination thereof.

4. The method of claim 1, wherein the first RS configuration associates the first RS with a first code division multiplexing (CDM) group, and wherein the second RS configuration associates the second RS with a second CDM group, wherein the first CDM group is orthogonal to the second CDM group.

5. The method of claim 4, wherein the first RS configuration associates the first CDM group with one of uplink (UL) communications or downlink (DL) communications in a full duplex transmission mode, a simultaneous transmission mode, or a simultaneous reception mode, and wherein the second RS configuration associates the second CDM group with one other of the UL communications or the DL communications.

6. The method of claim 4, wherein the first RS corresponds to a first RS port, wherein the second RS corresponds to a second RS port, and wherein the first RS port is associated with the first CDM group and the second RS port is associated with the second CDM group.

7. The method of claim 1, wherein the wireless node is a base station.

8. The method of claim 7, further comprising transmitting the first RS configuration and the second RS configuration.

9. The method of claim 7, wherein
communicating the first RS comprises transmitting, in a downlink (DL), the first RS to a first user equipment (UE), and
communicating the second RS comprises simultaneously receiving, in an uplink (UL), the second RS from a second UE.

10. The method of claim 7, wherein
communicating the first RS comprises transmitting, in a downlink (DL), the first RS to a user equipment (UE), and
communicating the second RS comprises simultaneously receiving, in an uplink (UL), the second RS from the UE.

11. The method of claim 8, wherein the first RS comprises a downlink (DL) RS corresponding to a resource set and wherein the second RS comprises an uplink (UL) RS corresponding to the resource set.

12. The method of claim 11, wherein the DL RS comprises:
a DL demodulation reference signal (DMRS),
a tracking reference signal (TRS),
a DL phase TRS, or
a channel state information RS (CSI-RS).

13. The method of claim 11, wherein the UL RS comprises:
a UL demodulation reference signal (DMRS),
a UL sounding reference signal (SRS), or
a UL phase tracking reference signal (TRS).

14. The method of claim 1, wherein the wireless node is a user equipment (UE).

15. The method of claim 14, further comprising receiving the first RS configuration and the second RS configuration.

16. The method of claim 14, wherein
communicating the first RS comprises receiving, in a downlink (DL), the first RS from a first base station, and
communicating the second RS comprises simultaneously transmitting, in an uplink (UL), the second RS to a second base station.

17. The method of claim 14, wherein
communicating the first RS comprises receiving, in a downlink (DL), the first RS from a base station, and
communicating the second RS comprises simultaneously transmitting, in an uplink (UL), the second RS to the base station.

18. The method of claim 15, wherein the first RS comprises a downlink (DL) RS corresponding to a resource set and wherein the second RS comprises an uplink (UL) RS corresponding to the resource set.

19. The method of claim 18, wherein the DL RS comprises:
a DL demodulation reference signal (DMRS),
a tracking reference signal (TRS),
a DL phase TRS, or
a channel state information RS (CSI-RS).

20. The method of claim 18, wherein the UL RS comprises:
a UL demodulation reference signal (DMRS),
a UL sounding reference signal (SRS), or
a UL phase tracking reference signal (TRS).

21. The method of claim 1, wherein the wireless node is a user equipment (UE), the method further comprising transmitting an RS orthogonality request, wherein at least one of the first RS configuration, the second RS configuration, or a combination thereof, is based at least in part on the RS orthogonality request.

22. The method of claim 1, wherein the wireless node is a base station, the method further comprising receiving an RS orthogonality request, wherein at least one of the first RS configuration, the second RS configuration, or a combination thereof, is based at least in part on the RS orthogonality request.

23. The method of claim 1, wherein based, at least in part on the first RS comprising an RS type that matches an RS type of the second RS, the first RS configuration associates the first RS with a first code division multiplexing (CDM) group and the second RS configuration associates the second RS with a second CDM group, wherein the first CDM group and the second CDM group have RS orthogonality relative to one another.

24. The method of claim 1, wherein, based at least on the first RS comprising an RS type that is different than an RS type of the second RS, the first RS configuration associates the first RS with a first set of resource elements (REs) and the second RS configuration associates the second RS with a second set of REs.

25. A method of wireless communication performed by an integrated access and backhaul (IAB) node in a multi-hop TAB network, the method comprising:
communicating a first reference signal (RS) based at least in part on a first RS configuration, and communicating, simultaneously with the first RS, a second RS based at least in part on a second RS configuration, wherein the second RS configuration orthogonalizes the second RS relative to the first RS.

26. The method of claim 25, wherein the first RS configuration associates the first RS with a first code division multiplexing (CDM) group, and wherein the second RS configuration associates the second RS with a second CDM group, wherein the first CDM group is orthogonal to the second CDM group.

27. The method of claim 25, wherein communicating the first RS comprises receiving the first RS from a parent node of the IAB node, and
wherein communicating the second RS comprises simultaneously receiving the second RS from one or more child nodes of the IAB node.

28. The method of claim 25, wherein communicating the first RS comprises transmitting the first RS to a parent node of the IAB node, and
wherein communicating the second RS comprises simultaneously receiving the second RS from one or more child nodes of the IAB node.

29. The method of claim 25, wherein communicating the first RS comprises transmitting the first RS to a parent node of the IAB node, and
wherein communicating the second RS comprises simultaneously transmitting the second RS to one or more child nodes of the IAB node.

30. The method of claim 25, wherein communicating the first RS comprises receiving the first RS from a parent node of the IAB node, and
wherein communicating the second RS comprises simultaneously transmitting the second RS to one or more child nodes of the IAB node.

31. The method of claim 25, wherein the IAB node comprises a mobile termination (MT) function in concurrent communication with a first parent node of the IAB node and a second parent node of the IAB node, the method further comprising:
receiving at least one of the first RS configuration, the second RS configuration, or a combination thereof from the first parent node of the IAB,
wherein the communication with the second parent node of the IAB is based at least in part on a negotiation communication between the first parent node of the IAB and the second parent node of the IAB.

32. The method of claim 25, wherein the IAB node comprises a mobile termination (MT) function in concurrent communication with a first parent node of the IAB node and a second parent node of the IAB node, the method further comprising:
receiving the first RS configuration from the first parent node of the IAB; and
transmitting an indication of the first RS configuration to the second parent node of the IAB, wherein the indication is to facilitate selection of the second RS configuration by the second parent node of the IAB.

33. A wireless node for wireless communication, comprising:
a memory; and
one or more processors operatively coupled to the memory, the memory and the one or more processors configured to:
communicate, using a first antenna panel, a first reference signal (RS) based at least in part on a first RS configuration, and
communicate, simultaneously with the first RS and using a second antenna panel that is different than the first antenna panel, a second RS based at least in part on a second RS configuration, wherein the second RS configuration orthogonalizes the second RS relative to the first RS.

34. An integrated access and backhaul (IAB) node for wireless communication, comprising:
a memory; and
one or more processors operatively coupled to the memory, the memory and the one or more processors configured to:
communicate a first reference signal (RS) based at least in part on a first RS configuration, and communicate, simultaneously with the first RS, a second RS based at least in part on a second RS configuration, wherein the second RS configuration orthogonalizes the second RS relative to the first RS.

35. An apparatus for wireless communication, comprising:
means for communicating, using a first antenna panel, a first reference signal (RS) based at least in part on a first RS configuration, and
means for communicating, simultaneously with the first RS and using a second antenna panel that is different than the first antenna panel, a second RS based at least in part on a second RS configuration, wherein the second RS configuration orthogonalizes the second RS relative to the first RS.
